(19) United States
(12) Patent Application Publication
(10) Pub. No.: US 2026/0238985 A1
(43) Pub. Date: Aug. 13, 2026

(54) METHOD OF STAND-ALONE NON-PUBLIC NETWORK (SNPN) ACCESS MANAGEMENT IN USER EQUIPMENT OPERATING AND A USER EQUIPMENT THEREOF

(71) Applicant: Samsung Electronics Co., Ltd., Suwon-si, Gyeonggi-do (KR)

(72) Inventors: Utsav SINHA, Bangalore (IN); Danish Ehsan HASHMI, Bangalore (IN); Lalith KUMAR, Bangalore (IN); Varini GUPTA, Bangalore (IN)

(21) Appl. No.: 19/155,777

(22) PCT Filed: Feb. 16, 2024
(86) PCT No.: PCT/KR2024/095345

§ 371 Date: Aug. 12, 2025

(30) Foreign Application Priority Data
Feb. 17, 2023 (IN) 202341010999
Feb. 2, 2024 (IN) 202341010999

(51) Int. Cl. H04W 8/18; H04W 8/20; H04W 48/18; H04W 84/04

(52) U.S. Cl. CPC H04W 8/183; H04W 8/20; H04W 48/18; H04W 84/042

(57) ABSTRACT

The disclosure relates to a 5G or 6G communication system for supporting a higher data transmission rate. The present disclosure discloses a method of SNPN access management in a User Equipment operating in SNPN access operation and the User Equipment thereof. The method recites storing a Network Identifier (NID) along with an identifier associated with a registered SNPN in a non-volatile memory of the UE. The method further recites utilizing the stored NID and the identifier associated with the registered SNPN for SNPN selection process after power-up of the UE.

### TECHNICAL FIELD

The present invention generally relates to the field of private 5G networks, and more particularly, relates to techniques for Stand-alone Non-Public Network (SNPN) access management in a User Equipment (UE) operating in SNPN access operation mode.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to a wireless communication system and, more specifically, the present disclosure relates to controlling method for a terminal operating in a stand-alone non-public network (SNPN) access operation mode in the wireless communication system.

### Solution to Problem

According to one aspect of the present disclosure, a method performed by a user equipment (UE) is provided. The method may includes identifying that the UE operating in an stand-alone non-public network (SNPN) operation mode and not registering for an onboarding service in a SNPN, determining whether the UE support access to the SNPN, and storing a network identifier (NID) associated with a registered SNPN based on the determination.

According to another aspect of the present disclosure, A user equipment (UE) is provided. The UE may includes at least one processor is configured to identify that the UE operating in an stand-alone non-public network (SNPN) operation mode and not registering for an onboarding service in a SNPN, determine whether the UE support access to the SNPN, and store a network identifier (NID) associated with a registered SNPN based on the determination.

### Advantageous Effects of Invention

According to an embodiment of present disclosure, an efficient and robust SNPN access management technique is provided.

### BRIEF DESCRIPTION OF DRAWINGS

The embodiments of the disclosure itself, as well as a preferred mode of use, further objectives, and advantages thereof, will best be understood by reference to the following detailed description of an illustrative embodiment when read in conjunction with the accompanying drawings. One or more embodiments are now described, by way of example only, with reference to the accompanying drawings in which:

FIG. 1 illustrates a call flow which describes a current problem wherein the UE cannot identify the new SNPN, in accordance with one embodiment.

FIG. 2 illustrates a call flow which describes the current problem wherein after power-up the UE is registering in SNPN-B which is not equivalent of last registered SNPN, in accordance with one embodiment.

FIG. 3 illustrates a call flow which illustrates the current problem wherein UE cannot identify the last registered SNPN after power-off and power-up in accordance with one embodiment.

FIG. 4 illustrates a user equipment (UE) operating in Stand-alone Non-Public Network (SNPN) access operation mode in accordance with one embodiment.

FIG. 5 illustrates a call flow which describes a solution in accordance with one embodiment.

FIG. 6 illustrates a call flow which describes a solution in accordance with one embodiment.

FIG. 7 illustrates a call flow which describes a solution in accordance with one embodiment.

FIG. 8 illustrates a method of Stand-alone Non-Public Network (SNPN) access management in a User Equipment (UE) operating in SNPN access operation mode in accordance with one embodiment.

It should be appreciated by those skilled in the art that any block diagrams herein represent conceptual views of the illustrative systems embodying the principles of the present subject matter. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### MODE FOR THE INVENTION

A Non-Public Network (NPN) is a 5GS deployed for non-public use, see 3GPP TS 22.261. An NPN is either a Stand-alone Non-Public Network (SNPN), i.e. operated by an NPN operator and not relying on network functions provided by a PLMN, or a Public Network Integrated NPN (PNI-NPN), i.e. a non-public network deployed with the support of a PLMN.

An SNPN is identified by an associated SNPN identity. The combination of a PLMN ID and Network identifier (NID) identifies an SNPN. NG-RAN nodes or trusted non-3GPP access networks which provide access to SNPNs broadcast the NID along with PLMN IDs to identify SNPN ID. It is assumed that an NG-RAN node supports broadcasting a total of twelve NIDs. The NID is also provided by the AMF in NAS Messages like REGISTRATION ACCEPT message. If the ESI bit of the 5GMM capability IE of the REGISTRATION REQUEST message is set to “equivalent SNPNs supported”, and the serving SNPN changes, the AMF shall indicate the NID of the serving SNPN in the REGISTRATION ACCEPT message. The UE shall determine the SNPN identity of the RSNPN from the NID received in the REGISTRATION ACCEPT message and the MCC and the MNC of the new 5G-GUTI.

Further, the SNPNs in the list of equivalent SNPNs associated with the selected entry of “list of subscriber data” or the selected PLMN subscription shall be regarded by the UE as equivalent to each other for SNPN selection, cell selection and cell re-selection. The list of equivalent SNPNs associated with the selected entry of “list of subscriber data” or the selected PLMN subscription is created, replaced or deleted at the end of each registration procedure. The stored list consists of a list of equivalent SNPNs as provided by the network plus the SNPN identity of the registered SNPN that provided the list.

The information disclosed in this background of the disclosure section is only for enhancement of understanding of the general background of the invention and should not be taken as an acknowledgement or any form of suggestion that this information forms the prior art already known to a person skilled in the art.

One or more shortcomings discussed above are overcome, and additional advantages and features are provided by the present disclosure. Other embodiments and aspects of the disclosure are described in detail herein and are considered a part of the disclosure.

In one non-limiting embodiment of the present disclosure, a method of Stand-alone Non-Public Network (SNPN) access management in a User Equipment (UE) operating in SNPN access operation mode is disclosed. The method recites storing a Network Identifier (NID) along with an identifier associated with a registered SNPN in a non-volatile memory of the UE. The method also recites utilizing the stored NID and the identifier associated with the registered SNPN for SNPN selection process after power-up of the UE.

In another non-limiting embodiment of the present disclosure, a part of the identifier associated with the registered SNPN comprises a Public Land Mobile Network ID (PLMN ID) and another part of the identifier is the NID.

In yet another non-limiting embodiment of the present disclosure, utilizing the stored NID and the identifier associated with the registered SNPN comprises using the stored NID and the identifier associated with the last registered SNPN during the SNPN selection process after the power-up to identify the last registered SNPN, and re-initiating registration with the last registered SNPN.

In yet another non-limiting embodiment of the present disclosure, utilizing the stored NID and the identifier associated with the registered SNPN comprises sending a registration message including the NID and the identifier associated with the last registered SNPN to a target SNPN for facilitating UE context transfer from the last registered SNPN to the target SNPN. The target SNPN is an equivalent SNPN or any other SNPN.

In yet another non-limiting embodiment of the present disclosure, the method further comprises updating the stored NID and the associated identifier in the non-volatile memory of the UE after successful registration with the target SNPN.

In yet another non-limiting embodiment of the present disclosure, when the UE supports access to an SNPN using credentials from a credentials holder, storing the NID of the registered SNPN in the non-volatile memory comprises one of: storing the NID of the registered SNPN and equivalent SNPNs of the registered SNPN in the non-volatile memory per subscribed SNPN along with an identifier associated with a selected entry in a list of subscriber data configured in the UE, or with a subscription permanent identifier (SUPI) from a Universal Subscriber Identity Module (USIM) if the identifier is non-configured in the selected entry of the list of subscriber data configured in the UE and the UE has a valid USIM, and storing the NID of the registered SNPN in the non-volatile memory per PLMN subscription along with a SUPI from a USIM which is associated with the PLMN subscription.

In yet another non-limiting embodiment of the present disclosure, a User Equipment (UE) operating in Stand-alone Non-Public Network (SNPN) access operation mode is disclosed. The UE comprises a non-volatile memory configured to store a Network Identifier (NID) along with an identifier associated with a registered SNPN, and a processing unit configured to utilize the stored NID and the identifier associated with the registered SNPN for SNPN selection process after power-up of the UE.

In another non-limiting embodiment of the present disclosure, a part of the identifier associated with the registered SNPN comprises a Public Land Mobile Network ID (PLMN ID) and another part of the identifier is the NID.

In yet another non-limiting embodiment of the present disclosure, to utilize the stored NID and the identifier associated with the registered SNPN, the processing unit is configured to use the stored NID and the identifier associated with the last registered SNPN during the SNPN selection process after the power-up to identify the last registered SNPN, and re-initiate registration with the last registered SNPN.

In yet another non-limiting embodiment of the present disclosure, to utilize the stored NID and the identifier associated with the registered SNPN, the processing unit is configured to send a registration message including the NID and the identifier associated with the last registered SNPN to a target SNPN for facilitating UE context transfer from the last registered SNPN to the target SNPN. The target SNPN is an equivalent SNPN or any other SNPN.

In yet another non-limiting embodiment of the present disclosure, the processing unit is further configured to update the stored NID and the associated identifier in the non-volatile memory after successful registration with the target SNPN.

In yet another non-limiting embodiment of the present disclosure, when the UE supports access to an SNPN using credentials from a credentials holder, processing unit is configured to selectively store the NID of the registered SNPN and equivalent SNPNs of the registered SNPN in the non-volatile memory per subscribed SNPN along with an identifier associated with a selected entry in a list of subscriber data configured in the UE, or with a subscription permanent identifier (SUPI) from a Universal Subscriber Identity Module (USIM) if the identifier is non-configured in the selected entry of the list of subscriber data configured in the UE and the UE has a valid USIM, and selectively store the NID of the registered SNPN in the non-volatile memory per PLMN subscription along with a SUPI from a USIM which is associated with the PLMN subscription.

The foregoing summary is illustrative only and is not intended to be in any way limiting. In addition to the illustrative aspects, embodiments, and features described above, further aspects, embodiments, and features will become apparent by reference to the drawings and the following detailed description.

For the purpose of promoting an understanding of the principles of the invention, reference will now be made to the various embodiments and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

The terms like “at least one” and “one or more” may be used interchangeably throughout the description. In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

As per 3GPP standards, if a user equipment (UE) is registering with a Stand-alone Non-Public Network (SNPN), the UE holds a valid 5G-GUTI that was previously assigned, over 3GPP access, by an equivalent SNPN, and the UE is not initiating the initial registration for onboarding services in SNPN, the UE shall indicate the 5G-GUTI in the 5GS mobile identity Information Element (IE) and shall additionally include the NID of the equivalent SNPN in the NID IE.

Further, if the UE is registering with an SNPN, the UE holds a valid 5G-GUTI that was previously assigned, over 3GPP access or non- 3GPP access, by any other SNPN, and the UE is not initiating the initial registration for onboarding services in SNPN, the UE shall indicate the 5G-GUTI in the 5GS mobile identity IE and shall additionally include the NID of the other SNPN in the NID IE.

Furthermore, in automatic SNPN selection mode procedure, the UE starts SNPN selection from the SNPN with which the UE was last registered or an equivalent SNPN. If the last visited registered Tracking Area Identity (TAI) is assigned by an SNPN other than the current SNPN, the serving Access and Mobility Management Function (AMF) can determine the SNPN assigning the last visited registered TAI using the NID provided by the UE. The last visited registered TAI is a TAI which is contained in the registration area that the UE registered to the network, and which identifies the tracking area last visited by the UE. The last visited registered TAI is indicated by the AMF in Non-Access Stratum (NAS) messages like REGISTRATION ACCEPT message. Further, a Registered SNPN (RSNPN) is the SNPN on which certain Limited Registration (LR) outcomes have occurred. In a shared network the RSNPN is the SNPN defined by the SNPN identity of the CN operator that has accepted the LR.

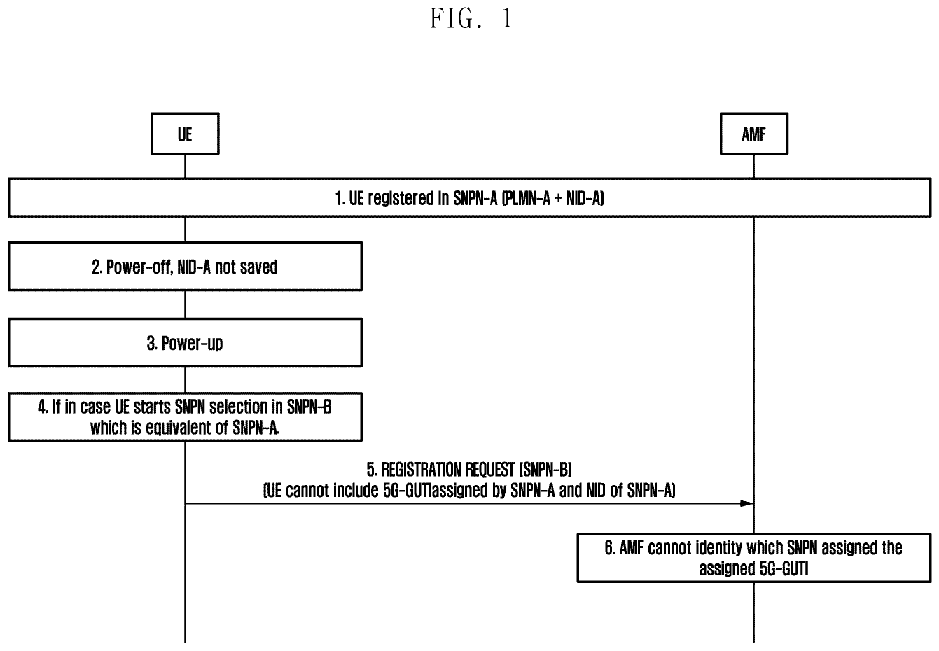

The above-mentioned requirements cannot be supported according to the existing techniques. For example, when the UE goes through a power cycle, the UE does not save the Network Identifier (NID) of the last registered SNPN. Thus, after power up of the UE, if the UE is registering with an SNPN, the UE holds a valid 5G-GUTI that was previously assigned, over 3GPP access, by an equivalent SNPN, and the UE is not initiating the initial registration for onboarding services in SNPN, the UE will not be able to include the NID of the equivalent SNPN in the NID IE. FIG. 1 illustrates a call flow which describes a current problem wherein the UE cannot identify that the new SNPN, where UE is registering after power-up is equivalent of last registered SNPN. Hence it cannot include the right 5G-GUTI assigned by the last SNPN and its NID.

Further, if the UE is registering with an SNPN, the UE holds a valid 5G-GUTI that was previously assigned, over 3GPP access or non- 3GPP access, by any other SNPN, and the UE is not initiating the initial registration for onboarding services in SNPN, the UE will not be able to include the NID of the other SNPN in the NID IE.

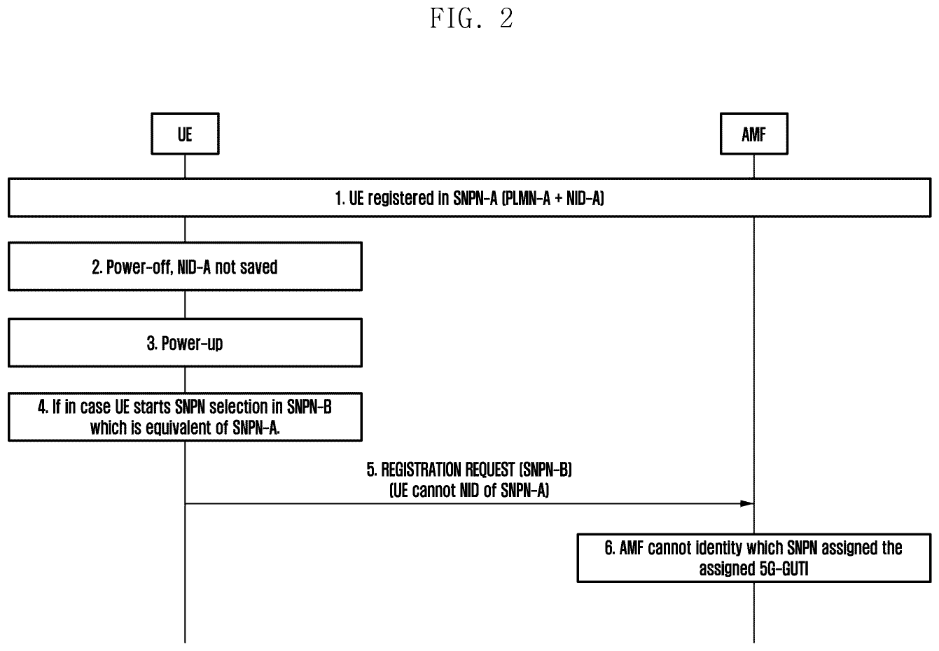

FIG. 2 illustrates a call flow which describes the current problem wherein after power-up the UE is registering in SNPN-B which is not equivalent of last registered SNPN, but the UE cannot include the NID of SNPN-A, although it might include the 5G-GUTI assigned by SNPN-A.

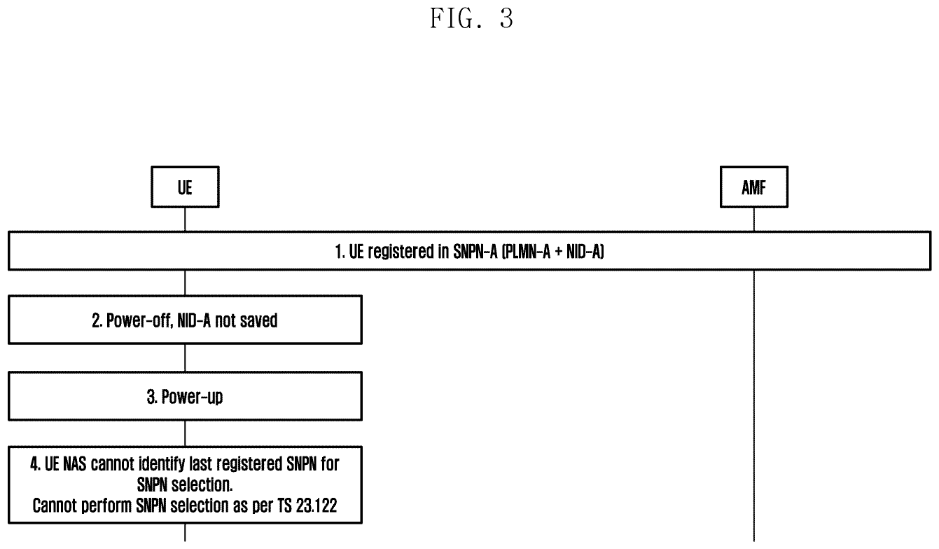

Similarly, if the UE is operating in SNPN access operation mode, the UE will be unable to determine the last registered SNPN, as NID is not part of the last registered TAI. If UE does not include the NID in the NAS message for example REGISTRATION REQUEST, and if the last visited registered TAI is assigned by an SNPN other than the current SNPN, the serving AMF cannot determine the SNPN assigning the last visited registered TAI using the NID provided by the UE. FIG. 3 illustrates a call flow which illustrates the current problem wherein UE cannot identify the last registered SNPN after power-off and power-up and hence cannot perform SNPN selection as per TS 23.122.

A skilled person would appreciate that the above limitations are not limited to power cycle, but for several other use cases as well, and the same are not limited to the NID of the registered SNPN alone, but also to it equivalent SNPNs. Thus, it is desired to address the mentioned disadvantages or other shortcomings and at least provide a useful alternative.

The present disclosure provides a solution to the above-mentioned problems. According to various embodiments of the present disclosure, along with the 5G-GUTI, last visited registered TAI and other 5GMM parameter values (as per Annex C.2 of 3GPP TS 24.501), the UEs operating in an SNPN access operation mode and not registering or registered for the onboarding service in SNPN, shall store the Network Identifier (NID) of the registered SNPN and its equivalent SNPNs in the non-volatile memory of the UE. The UE shall store the NID of the registered SNPN and its equivalent SNPNs in the non-volatile memory according to the following conditions.

If the UE does not support access to an SNPN using credentials from a credentials holder, the Network Identifier (NID) of the registered SNPN and it equivalent SNPNs shall be stored per subscribed SNPN in the non-volatile memory in the Mobile Equipment (ME) together with the subscriber identifier associated with the SNPN identity of the SNPN in a “list of subscriber data” configured in the ME (as per 3GPP TS 23.122) or with the SUPI from USIM if no subscriber identifier is configured in the entry of the “list of subscriber data” associated with the SNPN identity and the UE has a valid USIM.

If the UE supports access to an SNPN using credentials from a credentials holder, the Network Identifier (NID) of the registered SNPN and its equivalent SNPNs shall be stored in the non-volatile memory in the ME per: i) the subscribed SNPN together with the subscriber identifier associated with the selected entry in the “list of subscriber data” configured in the ME (as per 3GPP TS 23.122) or with the SUPI from the USIM if no subscriber identifier is configured in the selected entry of the “list of subscriber data” configured in the ME and the UE has a valid USIM; or ii) the PLMN subscription together with the SUPI from the USIM which is associated with the PLMN subscription.

According to another embodiment of the present disclosure, the UE may send the NID in NAS messages in combination of at least one of: last visited registered TAI/5G-GUTI/Additional GUTI, but not limited thereto. If the last visited registered TAI is assigned by an SNPN other than the current SNPN, the serving AMF may determine the SNPN assigning the last visited registered TAI using the NID provided by the UE. In this manner, the UE can register in with an SNPN after power-up.

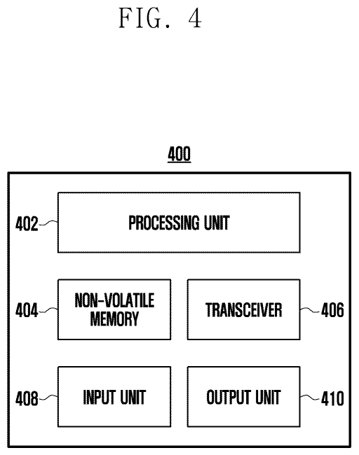

FIG. 4 illustrates a user equipment (UE) 400 operating in Stand-alone Non-Public Network (SNPN) access operation mode in accordance with various embodiments of the present disclosure. The UE 400 may comprise various elements such as a processing unit 402, a non-volatile memory 404, a transceiver 406, an input unit 408, and an output unit 410, but not limited thereto. The processing unit 402, the non-volatile memory 404, the transceiver 406, the input unit 408, and the output unit 410 may be communicatively coupled to each other and may interact with each other over a wired or wireless communication channel. Further, the processing unit 402 may comprise at least one processor which may include, but not restricted to, microprocessors, microcomputers, micro-controllers, central processing units, state machines, logic circuitries, and/or any devices that manipulate signals based on operational instructions. In an embodiment of the present disclosure, the processing unit 402 may also be implemented as a combination of devices, e.g., a combination of a plurality of microprocessors or any other such configuration. The non-volatile memory 404 may be communicatively coupled to the processing unit 402 and may also comprise various instructions. The processing unit may also comprise a memory which may be include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth. The processing unit 402 may be configured to execute one or more instructions stored in the memory. The memory may also store data processed by the processing unit 402.

The non-volatile memory 404 is configured to store the NID along with an identifier associated with a registered SNPN. The NID is a part of the identifier associated with the registered SNPN and another part may comprise a Public Land Mobile Network ID (PLMN ID). The processing unit 402 utilizes the stored NID and the identifier associated with the registered SNPN for SNPN selection process after power-up of the UE. In an embodiment, the processing unit 402 may use the stored NID and the identifier associated with the last registered SNPN during the SNPN selection/registration process after the power-up to identify the last registered SNPN. Using the NID, the processing unit 402 may re-initiate registration with the last registered SNPN.

In another embodiment of the present disclosure, the processing unit 402 of the UE 400 may send a registration message including the NID and the identifier associated with the last registered SNPN to a target SNPN for facilitating UE context transfer from the last registered SNPN to the target SNPN. In an embodiment, the target SNPN may be an equivalent SNPN or any other SNPN. Further, the processing unit 402 may also update the stored NID and the associated identifier in the non-volatile memory 404 after successful registration with the target SNPN.

In another embodiment of the present disclosure, when the UE 400 supports access to an SNPN using credentials from a credentials holder, the processing unit 402 may selectively store the NID of the registered SNPN and equivalent SNPNs of the registered SNPN in the non-volatile memory 404 per subscribed SNPN along with an identifier associated with a selected entry in a list of subscriber data configured in the UE 400, or with a subscription permanent identifier (SUPI) from a Universal Subscriber Identity Module (USIM) if the identifier is non-configured in the selected entry of the list of subscriber data configured in the UE and the UE has the valid USIM. Otherwise, the processing unit 402 may selectively store the NID of the registered SNPN in the non-volatile memory 404 per PLMN subscription along with a SUPI from a USIM which is associated with the PLMN subscription.

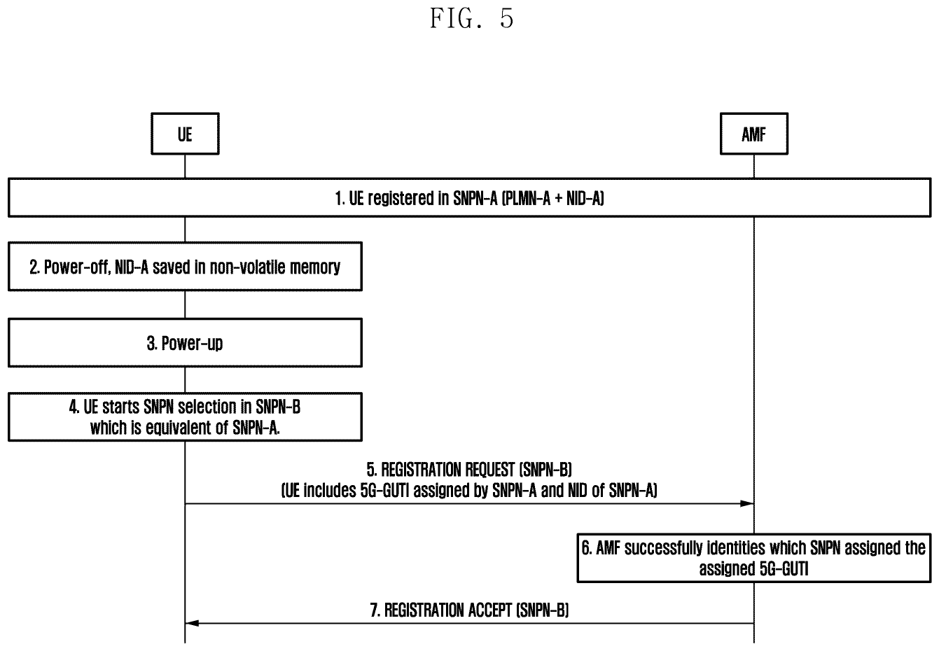

FIG. 5 illustrates a call flow which describes a solution in accordance with an embodiment of the present disclosure. As shown in step 1 of FIG. 5, the UE is registered with a SNPN-A. The UE may save the NID of the registered SNPN i.e. SNPN-A in the non-volatile memory, as shown in step 2. After power-up (at step 3), the UE may start SNPN selection of SNPN-B which is an equivalent of the SNPN-A, as shown at step 4. The UE may send a registration request for registration with the SNPN-B at step 5. In the request, the UE may include the right 5G-GUTI, assigned by the SNPN-A and its NID i.e., NID-A. Since the UE provided the NID and 5G-GUTI, the AMF may successfully identify which SNPN assigned the 5G-GUTI, at step 6. After successful identification of the SNPN-A, the UE may receive a REGISTARTION ACEEPT message from the AMF, at step 7.

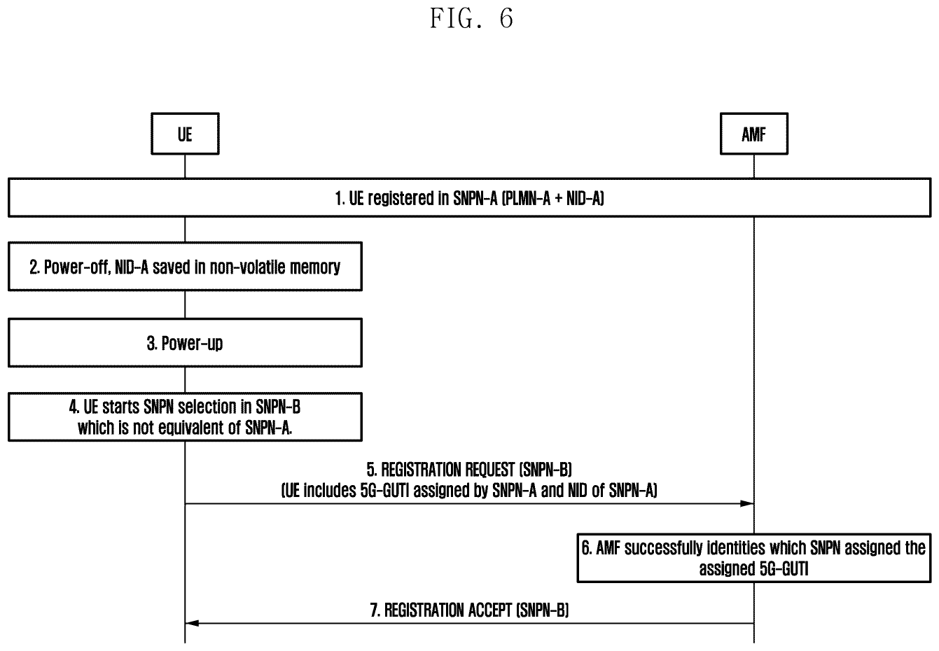

FIG. 6 illustrates a call flow which describes a solution in accordance with an embodiment of the present disclosure. As shown in step 1 of FIG. 6, the UE is registered with a SNPN-A. The UE may save the NID of the registered SNPN i.e. SNPN-A in the non-volatile memory, as shown in step 2. After power-up (at step 3), the UE may start SNPN selection of SNPN-B which is not an equivalent of the SNPN-A, as shown at step 4. The UE may send a registration request for registration with the SNPN-B at step 5. In the request, the UE may include the right 5G-GUTI, assigned by the SNPN-A and its NID i.e., NID-A. Since the UE provided the NID and 5G-GUTI, the AMF may successfully identify which SNPN assigned the 5G-GUTI, at step 6. After successful identification of the SNPN-A, the UE may receive a REGISTARTION ACEEPT message from the AMF, at step 7.

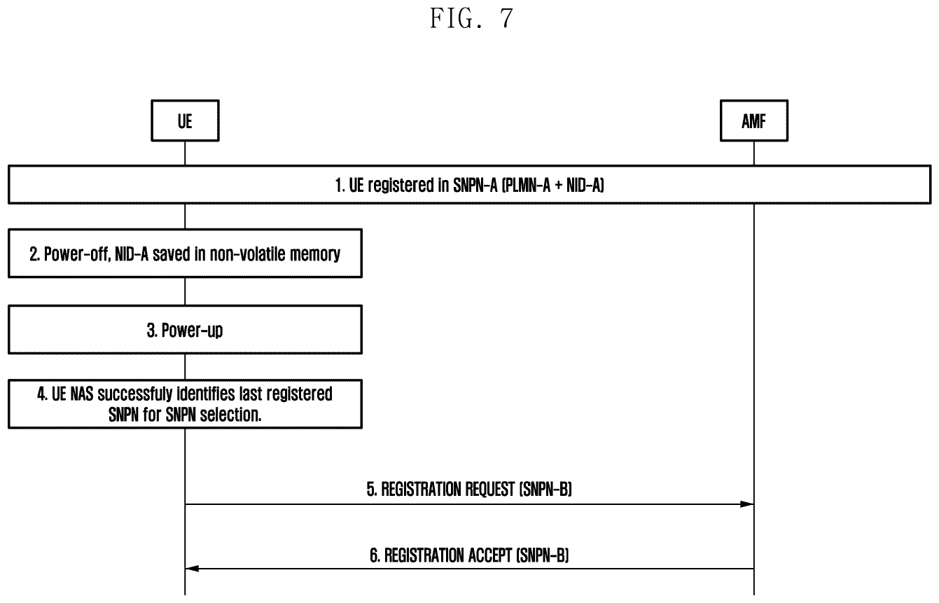

FIG. 7 illustrates a call flow which describes a solution in accordance with an embodiment of the present disclosure. As shown in step 1 of FIG. 7, the UE is registered with a SNPN-A. The UE may save the NID of the registered SNPN i.e. SNPN-A in the non-volatile memory, as shown in step 2. After power-up (at step 3), the last registered SNPN-A may be successfully identified by including the NID in the NAS message, as shown at step 4. The UE may send a registration request for registration with the SNPN-B to the AMF at step 5. Since the last registered SNPN was successfully identified, the UE may receive a REGISTARTION ACEEPT message from the AMF, at step 6.

In this manner, by storing the Network Identifier (NID) along with the associated identifier of the last registered SNPN in the non-volatile memory of the UE, the technique of the present disclosure ensures seamless registration during the SNPN selection process after power-up. The inclusion of the identifier ensures transfer of the UE context between SNPNs/AMF. Furthermore, storage of the identifier provides an efficient and robust SNPN access management technique.

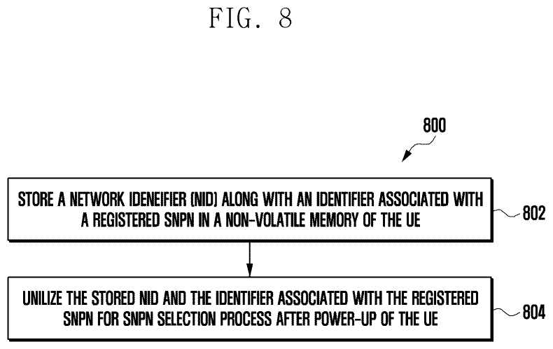

FIG. 8 of the present disclosure illustrates a method of Stand-alone Non-Public Network (SNPN) access management in a User Equipment (UE) operating in SNPN access operation mode in accordance with an embodiment of the present disclosure.

The blocks of the flow diagram shown in FIG. 8 have been arranged in a generally sequential manner for ease of explanation; however, it is to be understood that this arrangement is merely exemplary, and it should be recognized that the functionality/processing associated with method 800 (and the blocks shown in FIG. 8) can occur in a different order (for example, where at least some of the functionality/processing associated with the blocks is performed in parallel and/or in an event-driven manner).

At step 802, method 800 recites storing a Network Identifier (NID) along with an identifier associated with a registered SNPN in a non-volatile memory of the UE. In an embodiment, the NID is a part of the identifier associated with the registered SNPN and another part may comprise a Public Land Mobile Network ID (PLMN ID). In an embodiment, utilizing the stored NID and the identifier associated with the registered SNPN may comprise using the stored NID and the identifier associated with the last registered SNPN during the SNPN selection process after the power-up to identify the last registered SNPN and re-initiating registration with the last registered SNPN. In another embodiment, utilizing the stored NID and the identifier associated with the registered SNPN comprises sending a registration message including the NID and the identifier associated with the last registered SNPN to a target SNPN for facilitating UE context transfer from the last registered SNPN to the target SNPN. In an embodiment, the target SNPN may be an equivalent SNPN or any other SNPN. In another embodiment, when the UE supports access to an SNPN using credentials from a credentials holder, storing the NID of the registered SNPN in the non-volatile memory comprises one of: storing the NID of the registered SNPN and equivalent SNPNs of the registered SNPN in the non-volatile memory per subscribed SNPN along with an identifier associated with a selected entry in a list of subscriber data configured in the UE, or with a subscription permanent identifier (SUPI) from a Universal Subscriber Identity Module (USIM) if the identifier is non-configured in the selected entry of the list of subscriber data configured in the UE and the UE has a valid USIM, and storing the NID of the registered SNPN in the non-volatile memory per PLMN subscription along with a SUPI from a USIM which is associated with the PLMN subscription.

Further, at step 804, method 800 recites utilizing the stored NID and the identifier associated with the registered SNPN for SNPN selection process after power-up of the UE. The method further comprises updating the stored NID and the associated identifier in the non-volatile memory of the UE after successful registration with the target SNPN.

In this manner, by storing the Network Identifier (NID) along with the associated identifier of the last registered SNPN in the non-volatile memory of the UE, the method of the present disclosure ensures seamless registration during the SNPN selection process after power-up. By including the identifier, the method ensures transfer of the UE context between SNPNs/AMF. Thus, the disclosed method provides an efficient and robust SNPN access management technique.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the detailed description.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

It may be noted here that the subject matter of some or all embodiments described with reference to FIGS. 1-7 may be relevant for the methods and the same is not repeated for the sake of brevity.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

The terms “including”, “comprising”, “having” and variations thereof, when used in a claim, is used in a non-exclusive sense that is not intended to exclude the presence of other elements or steps in a claimed structure or method, unless expressly specified otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present disclosure are intended to be illustrative, but not limiting, of the scope of the invention, which is set forth in the appended claims.

1. A method performed by a user equipment (UE), the method comprising:
identifying that the UE operating in an stand-alone non-public network (SNPN) operation mode and not registering for an onboarding service in a SNPN;
determining whether the UE support access to the SNPN; and
storing a network identifier (NID) associated with a registered SNPN based on the determination.

2. The method of claim 1, wherein the NID is stored in a non-volatile memory in a mobile equipment (ME).

3. The method of claim 1, wherein, in case that the UE does not support access to the SNPN, the NID is stored per subscribed SNPN with a subscriber identifier associated with an SNPN identity of the SNPN in a list of subscriber data configured in an ME.

4. The method of claim 1, wherein, in case that the UE does not support access to the SNPN, the NID is stored per subscribed SNPN with a subscription permanent identifier (SUPI) from an universal subscriber identity module (USIM), when no subscriber identifier is configured in an entry of a list of subscriber data associated with an SNPN identity and the UE has a valid USIM.

5. The method of claim 1, wherein, in case that the UE supports access to the SNPN, the NID is stored per a subscribed SNPN with a subscriber identifier associated with a selected entry in a list of subscriber data configured in an ME.

6. The method of claim 1, wherein, in case that the UE supports access to the SNPN, the NID is stored per a subscribed SNPN with a SUPI from an USIM when no subscriber identifier is configured in a selected entry of a list of subscriber data configured in an ME and the UE has a valid USIM.

7. The method of claim 1, wherein, in case that the UE supports access to the SNPN, the NID is stored per a public land mobile network (PLMN) subscription with a SUPI from an USIM associated with the PLMN subscription.

8. A user equipment (UE), comprising:
at least one processor is configured to:
identify that the UE operating in an stand-alone non-public network (SNPN) operation mode and not registering for an onboarding service in a SNPN,
determine whether the UE support access to the SNPN, and
store a network identifier (NID) associated with a registered SNPN based on the determination.

9. The UE of claim 8, further comprising:
a non-volatile memory;
wherein the NID is stored in the non-volatile memory.

10. The UE of claim 8, wherein, in case that the UE does not support access to the SNPN, the NID is stored per subscribed SNPN with a subscriber identifier associated with an SNPN identity of the SNPN in a list of subscriber data configured in a mobile equipment (ME).

11. The UE of claim 8, wherein, in case that the UE does not support access to the SNPN, the NID is stored per subscribed SNPN with a subscription permanent identifier (SUPI) from an universal subscriber identity module (USIM), when no subscriber identifier is configured in an entry of a list of subscriber data associated with an SNPN identity and the UE has a valid USIM.

12. The UE of claim 8, wherein, in case that the UE supports access to the SNPN, the NID is stored per a subscribed SNPN with a subscriber identifier associated with a selected entry in a list of subscriber data configured in an ME.

13. The UE of claim 8, wherein, in case that the UE supports access to the SNPN, the NID is stored per a subscribed SNPN with a SUPI from an USIM when no subscriber identifier is configured in a selected entry of a list of subscriber data configured in an ME and the UE has a valid USIM.

14. The UE of claim 8, wherein, in case that the UE supports access to the SNPN, the NID is stored per a public land mobile network (PLMN) subscription with a SUPI from an USIM associated with the PLMN subscription.
